(19) United States
(12) Patent Application Publication
(10) Pub. No.: US 2019/0071282 A1
(43) Pub. Date: Mar. 7, 2019

(54) SUPPORTING MEANS FOR AN ELEVATOR INSTALLATION, WITH MULTIPLE SENSORS ARRANGED ALONG THE SUPPORTING MEANS

(71) Applicant: Inventio AG, Hergiswil (CH)

(72) Inventor: Volker Zapf, Kriens-Obernau (CH)

(21) Appl. No.: 16/083,005

(22) PCT Filed: Mar. 2, 2017
(86) PCT No.: PCT/EP2017/054919

§ 371 Date: Sep. 7, 2018

(30) Foreign Application Priority Data
Mar. 10, 2016 (EP) 16159641.6

(51) Int. Cl. B66B 7/12

(52) U.S. Cl. CPC B66B 7/1215; D07B 1/145

(57) ABSTRACT

A supporting belt for an elevator installation has at least one elongate load-bearing element, a casing surrounding the load-bearing element and multiple sensors. The sensors are arranged on the belt at multiple positions spaced apart from one another along a longitudinal direction of the belt. The sensors each determine at least one physical characteristic of the load-bearing element in a region locally adjacent to the respective sensor and output a signal indicating the physical characteristic. For example, a sensor may determine a local expansion, a local bending, a local acceleration, a locally acting force, a local temperature and/or an electrical conductivity at, in or through the belt. The state of the belt can thereby be determined not only as an average for the entire belt but with regard to multiple positions along the length of the belt, enabling an improved determination regarding discard criteria of the belt.

### FIELD

The present invention relates to a supporting means, such as a belt, for an elevator installation, and to an elevator installation equipped therewith, and to a method for monitoring a state of a supporting means.

### BACKGROUND

Elevator systems are generally used to transport passengers or objects in a building usually in the vertical direction. In this case, an elevator car is generally moved inside an elevator shaft. The elevator car is held in this case by a supporting means. A supporting means of this kind may comprise, for example, one or more cables or one or more belts. The supporting means can be moved using a drive, in order to displace the elevator car held thereon. The drive may comprise, for example, a motor that drives a drive sheave in a rotatory manner in order to be able to move the supporting means extending over the drive sheave.

Suspension means used for elevator installations usually comprise one or preferably multiple elongate load-bearing elements. Load-bearing elements of this kind may be, for example, individual wires or strands or multiple wires or strands of this kind, which are usually stranded or combined in another way, in order to form stranded tensile supports, for example. Load-bearing elements are sometimes also referred to as cords. The load-bearing elements may consist of materials that are highly resistant to mechanical tension. For example, the load-bearing elements may consist of metal, in particular of steel. Alternatively, non-metallic materials, such as synthetic materials, in particular synthetic fibers such as carbon fibers, Kevlar fibers etc., may also be used for load-bearing elements.

In order to, for example, protect load-bearing elements from mechanical damage and/or corrosion and increase the traction, said elements are usually surrounded by a casing. A casing of this type may completely or partially enclose an individual load-bearing element or multiple load-bearing elements. In other words, one or more load-bearing elements can be embedded in a matrix, forming the casing, made of a mechanically and/or chemically resilient material. The casing may consist of a plastics material, for example. In particular, elastomeric materials, such as polyurethane, are frequently used for casings of this type.

Suspension means are frequently subject to high mechanical loads during operation of an elevator installation. For example, the supporting means have to be reliably held statically and dynamically the loads produced by an elevator car suspended thereon and optionally also the loads produced by a counterweight suspended thereon. In this case, the supporting means is moved and frequently deflected multiple times over a drive sheave and/or pulleys. Additional load is applied to the drive sheave due to the traction. In particular, repeated bending of the supporting means in this manner under load may lead to increased wear on the supporting means during the service life of the elevator installation, for example due to material fatigue and mechanical external abrasion.

As the supporting means must inter alia hold the elevator car together with the passengers and various load conditions that may be inside and is therefore regarded as a safety-related component inside the elevator installation, it must always be ensured that the supporting means can reliably carry out its function of holding the elevator car. For example, there may be regulations which allow the operation of the elevator installation only if sufficient monitoring of the integrity of the supporting means can be ensured.

In the case of conventional supporting means in the form of unsheathed steel cables, for example, the integrity of the supporting means can be monitored for example by visually inspecting the steel cable along the entire length thereof during the service interval. Human maintenance personnel can inspect the supporting means of an elevator installation on-site at regular time intervals and thereby check signs of mechanical wear and the permissible number of journeys, for example.

In the case of supporting means in which a casing surrounds one or more load-bearing elements, such a visual inspection of expected wear is usually not possible as only the casing can be seen from outside and it is not possible to identify whether load-bearing elements accommodated therein are damaged. Only unforeseen mechanical damage can be identified visually.

Alternative methods have therefore been developed in order to be able to ensure the integrity of a supporting means of this kind comprising unsheathed load-bearing elements. In this case, one or more physical characteristics of the supporting means are usually monitored in order to be able to draw conclusions regarding the state of the supporting means. The discard criteria according to the permissible number of journeys achieved is essential here.

For example, methods have been developed in order to be able to draw conclusions regarding the integrity of the supporting means by conducting an electric current through electrically conductive load-bearing elements of a supporting means and determining, for example, an electrical resistance taking effect in this case. Methods of this type and/or aspects related to said methods have been disclosed inter alia in EP 1 730 066 B1, U.S. Pat. No. 7,123,030 B2, US 2011/0284331 A1, U.S. Pat. No. 8,424,653 B2, US 2008/0223668 A1, U.S. Pat. No. 8,011,479 B2 and US 2013/0207668 A1. Other approaches are also disclosed in WO 2011/098847 A1, WO 2013/135285 A1, EP 1 732 837 B1 and in a scientific article by Huaming Lei et al.: “Health Monitoring for Coated Steel Belts in an Elevator System” in Journal of Sensors, Volume 2012, Article ID 750261, 5 pages, DOI: 10.1155/2012/750261.

US 2014/0306829 A1 further discloses a tension sensor assembly, using which correct tension in an elevator cable can be detected and corrected if necessary. WO 2011/131574 A1 discloses monitoring the operating state of supporting means in an elevator installation. WO 2012/004268 A1 discloses a possibility for monitoring supporting means in an elevator installation. WO 2010/007112 A1 discloses a method and a device for determining the discard criteria of a supporting means of an elevator.

### SUMMARY

There may be inter alia a need for a supporting means, an elevator installation equipped with a supporting means of this kind, and a method for monitoring a state of a supporting means, in the case of all of which a state of the supporting means can be advantageously monitored and in particular the integrity of the supporting means can be checked reliably. There may further be a need for a supporting means, an elevator installation, and/or a monitoring method, in the case of all of which opportunities are created to advantageously determine, by means of suitable technical measures, the state of wear of the supporting means and optionally to be able to determine a discard criteria of the supporting means with high precision and/or reliability.

The subject matter of the invention can meet at least one such need. Advantageous embodiments are set out in the following description.

According to a first aspect of the present invention, a supporting means for an elevator installation is proposed, the supporting means comprising at least one elongate load-bearing element, a casing surrounding the load-bearing element, and a multiplicity of sensors. In this case, the sensors are arranged on the supporting means at multiple positions that are spaced apart from one another along a direction of longitudinal extent of the supporting means. The sensors are designed to determine at least one physical characteristic of the supporting means in a region locally adjacent to the respective sensor and to output a signal which indicates the determined physical characteristic.

According to a second aspect of the invention, an elevator installation is proposed which comprises an elevator car, a drive, and a supporting means according to an embodiment of the above-mentioned first aspect of the invention. The elevator car is held on the supporting means in this case and is to be displaced by the supporting means being moved by means of the drive.

According to a third aspect of the invention, a method for monitoring a state of the supporting means according to an embodiment of the above-mentioned first aspect of the invention is proposed. The method comprises the following steps: First, signals are received that each indicate a determined physical characteristic of a supporting means, which physical characteristic has been determined by sensors attached to the supporting means at multiple different positions. The received signals are then processed appropriately in order to determine information regarding the state of the supporting means therefrom.

Possible features and advantages of embodiments of the present invention may be considered, among others and without limiting the invention, to be based on the ideas and findings described below.

As indicated in the introduction, the integrity of a supporting means in an elevator installation must always be ensured. Different measures and/or methods were therefore developed, as also indicated in the introduction, in order to be able to monitor a state of a supporting means.

However, these conventional approaches for monitoring the supporting means are generally designed such that physical characteristics of the supporting means are monitored as a whole. For example, in proposed monitoring methods in which an electric current is conducted through a load-bearing element of the supporting means and the active electrical resistance is observed, the electric current is usually coupled into the supporting means at one end thereof and decoupled at the other end, such that current flows through the entire supporting means along the entire length thereof. If an unusual increase in the electrical resistance through the supporting means is established, damage to the load-bearing element accommodated therein can be inferred. If necessary, countermeasures can then be taken and/or the supporting means can be replaced.

A disadvantage of these known solutions is distinguishing, on the basis of the information obtained regarding the entire length of the supporting means, whether there is significant local damage or long wear over the length, as the resistance values may be identical. This therefore has a significant influence on the remaining breaking load of the supporting means.

Furthermore, conventional approaches of this kind in particular cannot provide information regarding where, i.e. at which position, damage has occurred on the supporting means.

Furthermore, conventional approaches of this kind usually do not permit monitoring characteristics of the supporting means that allow conclusions to be drawn regarding a current state of the supporting means before damage to the supporting means has actually become apparent. For example, when monitoring the electrical resistance through the supporting means, a deterioration in the state of the supporting means can only be identified when the electrically conductive load-bearing element accommodated therein has actually been damaged and therefore there has been an increase in resistance. However, stages of a change in a state of the supporting means that precede actual damage cannot generally be identified in this way.

A modified supporting means for an elevator installation is therefore proposed, in the case of which supporting means characteristics of one or more load-bearing elements at multiple positions along the supporting means can be monitored, such that not only can the fact that physical characteristics in a load-bearing element change be determined, but also location information regarding the region of the supporting means in which a change of this kind has occurred can be determined.

For this purpose, it is proposed here to provide the supporting means with a multiplicity of sensors. These sensors should not only be arranged at one or both of the opposing ends of the supporting means, but also at a plurality of different positions preferably along the entire longitudinal extent of the supporting means.

Each of the sensors should be designed in this case to measure or determine one or more physical characteristics of the supporting means, or of a load-bearing element accommodated in the casing of the supporting means, in a region locally adjacent to the respective sensor.

The wording “physical characteristic of the supporting means” should be broadly interpreted here and should comprise both physical characteristics of one or more load-bearing elements accommodated in the supporting means, or physical characteristics of the casing, and physical characteristics in the immediate surrounding region that influence the supporting means. Examples are explained further below.

The “region locally adjacent to the respective sensor” may in this case be interpreted such that each position on the supporting means inside this region is closer to the respective sensor than any of the other sensors provided on the supporting means. Each position along the supporting means is therefore associated with one of the plurality of regions locally adjacent to one of the respective plurality of sensors.

In order to implement the supporting means proposed herein, the fact that a number of sensors that can be used at various positions along the supporting means have already been developed for other fields of technology can be used advantageously inter alia. In particular, small or even miniaturized sensors that can be attached without difficulty to a supporting means of an elevator installation or can even be integrated in said supporting means have been developed.

For example, sensors in the form of miniaturized components based on semiconductors have been developed, using which sensors physical characteristics can be detected by means of a component formed, for example, on a microchip. Sensors of this kind may have dimensions and structures due to which they can be attached or placed on or preferably in a casing of a supporting means in a simple and reliable manner. For example, sensors of this kind may have dimensions of a few centimeters or even only a few millimeters; in particular, they may be smaller than 5 cm, smaller than 2 cm or smaller than 1 cm. Furthermore, sensors which appear to be advantageous for use in a supporting means of an elevator installation not only on the basis of their dimensions, but also on the basis of their ability to be treated and processed, and which in principle do not negatively influence the service life of the supporting means have been developed.

For example, sensors have been developed for use in motor vehicle tires that can be integrated into an elastomer mixture of a tire and can measure, on the tire, the internal pressure of the tire and/or accelerations occurring there, for example. It is assumed that sensors of this kind can also be advantageously used in supporting means for elevator installations.

The sensors provided along the supporting means may be designed to determine, as a physical characteristic, a local expansion of the supporting means, a local bending of the supporting means, a local acceleration of the supporting means, a force acting locally on the supporting means, a local temperature of the supporting means and/or an electrical conductivity through the load-bearing element of the supporting means.

Each of the physical characteristics determined by a sensor of this kind can be used in principle to derive information regarding a current state of the supporting means. This makes it possible to determine information which, for example, can give an indication of existing damage to the load-bearing element of the supporting means or which, at best, can already give an indication of changes inside the supporting means that may lead to damage of this kind.

For example, mechanical stress on the supporting means and in particular on the load-bearing element accommodated therein may lead over time to signs of material fatigue. During operation of an elevator installation, the load-bearing element is repeatedly expanded in a manner that is to be considered normal, for example when the load accommodated in an elevator car and therefore held by the supporting means temporarily changes. In addition, the supporting means may be expanded in an unusual manner occasionally, for example in the case of emergency braking. An expansion of the supporting means and of the load-bearing elements accommodated therein may be more distinct in specific regions of the supporting means than in other regions. For example, where a supporting means is currently being deflected by a roller, for example, a locally increased expansion may occur when the load changes. Local expansions of the supporting means and in particular of load-bearing elements accommodated therein may have a wear-promoting effect.

In addition, during operation of the elevator installation, the supporting means is repeatedly bent locally, for example when being deflected around the roller, it having been observed that such a bending of the supporting means can strongly promote the wear of said supporting means.

The possibility of locally monitoring, using the plurality of sensors provided on the supporting means, whether the supporting means is expanded and/or bent in portions allows valuable information to be derived regarding the mechanical stress on the supporting means during use thereof. In particular, it can be identified, for example, that the supporting means has been particularly frequently deflected, and thereby bent, in specific portions, and therefore that the risk of damage in these regions is particularly high. Information of this kind may be used, for example, in order to focus other inspection measures specifically on these regions, or in order to reduce load on the supporting means specifically in these regions by means of appropriate measures.

A sensor can monitor a local acceleration of the load-bearing element as another physical characteristic. Monitoring local accelerations of this kind can indicate the extent to which the respective region of the supporting means is mechanically stressed. Observing an excessively rapid local acceleration in a region of the supporting means may also be suggestive of an existing defect in the supporting means. The local accelerations may be measured in one or more spatial directions. Preferably, local accelerations are measured at least in a direction that is transverse to a direction of longitudinal movement of the supporting means.

The sensor can determine a force acting locally on the load-bearing element as another physical characteristic. Locally acting forces of this kind may, although do not necessarily have to, produce accelerations on the load-bearing element. However, said forces usually function as mechanical load and therefore as potentially wear-increasing.

A local temperature of the supporting means may be determined as another physical characteristic to be monitored. The temperature in portions of the supporting means may change over time due to various influences. In the simplest case, only the ambient temperature in an elevator shaft, for example, can change. Changes in temperature of this kind are usually large-scale, i.e. not restricted to local regions of the supporting means, and are generally non-critical.

Local changes in temperature only in portions of the supporting means may, however, be suggestive of potentially damaging conditions or may already be a result of local damage to the supporting means. For example, a permanent increase in temperature that is restricted to a small portion of the supporting means may be suggestive of local damage to the supporting means or other components that are locally in thermal contact therewith. An increase in temperature that occurs repeatedly or is temporary in a portion of the supporting means may suggest, for example, that the supporting means is repeatedly conveyed past a hot region or object such as an overheated drive sheave or pulley. Local increases in temperature due to fires in or adjacent to an elevator shaft can be identified by monitoring the temperature of the load-bearing elevator and, for example, advantageous countermeasures such as restricting the travel distance of an elevator installation can be introduced.

Information regarding local prevailing temperatures to be determined by a sensor or a plurality of sensors on the supporting means can therefore be used to derive information not only regarding the state of the supporting means, but also regarding other environmental conditions that are significant for operating an elevator installation.

Furthermore, an electrical conductivity through the load-bearing element may be determined as a physical characteristic to be monitored. An electrical conductivity of this kind may also be determined, for example, locally between two adjacent sensors, such that changes in conductivity not only along the entire supporting means but also inside portions of the same can be identified and e.g. conclusions regarding local damage can be drawn therefrom.

A sensor may be designed to determine an individual physical characteristic. However, sensors may be used that can determine multiple various physical characteristics and transmit corresponding measuring signals. For example, a sensor may be able to measure both accelerations and temperatures. In this case, a sensor may be designed to determine one or more physical characteristics continuously, quasi-continuously, or at time intervals, preferably periodically. The signals which indicate the determined physical characteristics may also be output continuously, quasi-continuously, or at time intervals, preferably periodically.

According to a further embodiment, the sensors may be designed to transmit the signal which indicates the determined physical characteristic to a remote control system and an external monitoring apparatus.

In other words, the sensors should be capable not only of monitoring a physical characteristic of the supporting means and, for example, storing the measured results obtained, but also of providing relevant measuring signals to a remote control system.

This control system may be arranged in another region of the elevator installation or even outside the elevator installation, i.e. in a remote control center, for example. In this case, the control system may be designed to process and evaluate the signals received from the sensors in order to be able to determine the desired information regarding the state of the supporting means. A current state of the supporting means can therefore be monitored from a remote location by means of the supporting means proposed herein and the measuring signals provided to external locations by the sensors arranged on said supporting means. A telemonitoring system made possible by this can, for example, allow an online query of a current state of the supporting means at any time without a person having to inspect the supporting means locally for this purpose, for example. This allows timely service planning and minimizes downtime of the elevator installation, for example.

According to an embodiment, the sensors may in particular be designed to transmit their signals wirelessly to the remote control system. Wireless signal transmission of this kind can take place using radio signals or similar, for example. For this purpose, a sensor may also comprise a wireless signal transmission unit in addition to a measuring unit, which transmission unit can translate the measured signals into radio signals and transmit them to the external control system. The signal transmission unit may be designed to send and/or receive signals. This can in particular significantly reduce the required wiring for the supporting means proposed herein.

Additionally or alternatively, according to an embodiment, at least one of the sensors may be designed and in contact with the at least one load-bearing element such that a signal can be transmitted between the respective sensor and a remote control system through the load-bearing element.

In other words, the sensors do not necessarily need to be designed to wirelessly transmit signals. Alternatively or additionally, the sensors can also transmit the measuring signals determined thereby to a remote control system, for example, via a load-bearing element of the supporting means that mostly consists of an electrically conductive material in any case. Signal transmission of this kind is frequently less prone to disruption than wireless signal transmission, in particular in a narrow elevator shaft that is often provided with a plurality of metal components. Additional wiring required for each of the sensors can be prevented or minimized in this case, as no additional cables are required on the supporting means for signal transmission, but rather signal transmission of this kind can take place via the load-bearing element that functions as a data line in this case.

A plurality of sensors can, for example, transmit their signals to an external location via various load-bearing elements provided in the supporting means. Alternatively, multiple sensors may transmit their signals via the same load-bearing element, each sensor being able, for example, to encode the signals transmitted therefrom in an individual way or mark said signals with an individual marker, in order to e.g. make it possible for an external control system to be able to distinguish between signals coming from different sensors.

According to an embodiment, at least part of a sensor is designed and arranged such that it penetrates the casing of the supporting means and comes into contact with the load-bearing element. In a design of this kind, a sensor may be arranged on an outer surface of the supporting means and fastened there. In principle, a sensor can be attached to any outer surface of the supporting means; however, it may be preferable to arrange the sensor on a rear surface that does not come into contact with drive sheaves and/or pulleys or comes into contact therewith less than an opposing, front-side contact surface of the supporting means. Conventional supporting means or even supporting means that are already installed in particular can be retrofitted with corresponding sensors. The casing only needs to be locally opened or penetrated in order to allow the sensor to make mechanical, electrical and/or thermal contact with the load-bearing element surrounded by the casing. For example, a sensor may comprise contact needles that can be pierced through the casing and pressed into the load-bearing element. As a result, a supporting means can be retrofitted with at least one sensor or a plurality thereof even after (initial) installation.

According to a further embodiment, at least one of the sensors may be integrated in the casing around the load-bearing element. In other words, a sensor may be completely accommodated or embedded in the casing. The sensor can therefore virtually become part of the supporting means. In this case, the sensor may be sheathed by the casing in a similar way to the load-bearing element and may, for example, be protected against external mechanical or chemical influences. Although it is almost impossible to retrofit existing supporting means with sensors in this case, the sensors can be cast directly into an elastomer casing, for example, during production of the supporting means, for example. The sensors can be integrated in the supporting means such that said sensors are advantageously in mechanical, electrical and/or thermal contact with one or more load-bearing elements.

According to an embodiment, at least one of the sensors is designed to determine the physical characteristics and transmit the relevant signal without a separate energy supply. A sensor of this kind may be referred to as “passive”, as it cannot become active on its own without external influences and can only be read out passively at most. “A separate energy supply” is understood in this case to mean an energy source, such as a specifically associated battery, that is associated with only one individual sensor.

Providing the supporting means with passive sensors of this kind can simplify both manufacture and maintenance of the supporting means, as, for example, it is not necessary to provide, maintain and/or replace a large number of batteries for the large number of sensors at regular intervals.

It is conceivable, for example, that electrical or magnetic characteristics of a sensor, for example, change depending on the physical characteristics of the load-bearing element in an adjacent local region that have an effect thereon, and that these changed characteristics, for example, can be read out from the outside. For example, electromagnetic radiation could be emitted from a control system to the sensor and reflected by the sensor in a modified manner depending on currently prevailing conditions and then the reflected radiation could be detected and evaluated by the control system.

Alternatively, the sensor may be designed for self-sufficient energy production, e.g. by providing suitable energy-generating elements, e.g. at least one piezo element. As another alternative, energy could be supplied externally, e.g. by means of an RF signal, on an ad hoc basis. This energy can be stored in a suitable energy storage element, so that the sensor can be operated at least for a specific time after energy has been produced or supplied externally. The time between two journeys, for example, can therefore be bridged, which journey either generates energy (piezo technology) or alternatively brings a sensor near the energy source (externally supplied energy).

According to a further embodiment, at least one of the sensors may be designed and in contact with the at least one load-bearing element such that the sensor is supplied with electrical energy via an electric current flow through the load-bearing element.

In other words, a sensor does not have to be “passive” in the above-mentioned sense; however, it is not necessary to establish an energy supply to the sensor via a large number of decentralized energy sources, such as batteries, that are associated with each sensor. Instead, electrical energy can be provided to the sensors via the load-bearing element, which is usually electrically conductive in any case, of the supporting means. Electrically mutually isolated regions of a load-bearing element or, preferably, of two separate electrically conductive load-bearing elements can be used in this case as electrical conductors to which, for example, an electrical voltage can be applied externally and which can therefore function as leads for providing an electrical energy supply for one or more sensors attached thereto.

According to a further embodiment, the supporting means comprises multiple mutually parallel load-bearing elements and the sensors are designed to determine the at least one physical characteristic in at least one of the load-bearing elements, although preferably in a plurality or even all of the load-bearing elements, in a region locally adjacent to the respective sensor.

In other words, the supporting means may, similarly to the belts conventionally used as supporting means of an elevator installation, be equipped with a multiplicity of elongate load-bearing elements, commonly referred to as cords, that are jointly accommodated in a single casing. Sensors may be arranged on or in the supporting means, or on or in the casing thereof, at suitable spacings longitudinally along the supporting means. In this case, each sensor can determine one or more physical characteristics in one or more of the load-bearing elements in an adjacent region and output corresponding signals outwards.

According to a further embodiment, the sensors may be arranged along the direction of longitudinal extent of the supporting means so as to be equidistantly spaced apart from one another. In other words, a spacing between sensors that are adjacent in the direction of longitudinal extent may be the same for all of the sensors provided on the supporting means. A supporting means can therefore be manufactured and provided as a standardized and/or pre-fabricated component. For example, a supporting means in the form of a belt, having a very long length, equipped with sensors may be produced and then cut up in corresponding lengths for a specific usage case.

In principle, however, spacings between sensors that are adjacent in the direction of extent of the supporting means cannot be equidistant. For example, it is conceivable to select the spacings between sensors in regions that appear to be particularly worth monitoring such that said spacings are narrower than in less vulnerable regions.

Depending on the physical characteristic to be determined and/or the desired local resolution in the case of the physical characteristic to be determined, a spacing between adjacent sensors can be selected as appropriate. For example, a spacing between adjacent sensors of from a few centimeters, for example 10 cm, to a plurality of meters, for example 5, 10 or even 20 m, may be selected.

In the case of an elevator installation that is equipped with a supporting means according to the invention, a monitoring apparatus may furthermore be provided that is designed to receive a signal which indicates the determined physical characteristic from various sensors attached to the supporting means and to determine information regarding a current state of the supporting means by processing received signals.

The monitoring apparatus may be arranged so as to be remote from the supporting means in this case. Signals may be transmitted between the sensors and the monitoring apparatus, for example, wirelessly, via specifically provided wiring on the supporting means, or by transmitting the signals through the electrically conductive load-bearing elements provided in the supporting means.

The monitoring apparatus may be designed to carry out a method according to an embodiment of the third aspect of the present invention, i.e. to process the signals received from the various sensors in order to determine information regarding a state of the supporting means.

In this case, it may be advantageous if, while the received sensor signals are being processed, information regarding the position at which the sensor is arranged on the supporting means is available, in addition to the information contained in said sensor signals regarding the physical characteristic determined by the sensor. Information of this kind can be either transmitted by the sensor, together with the signals which indicate the physical characteristic, or derived in another way.

For example, a “learning phase” can be carried out after the supporting means has been installed in the elevator installation, during which learning phase, for example, the supporting means is deliberately displaced by a drive of the elevator installation and a behavior of the sensors attached to the supporting means and/or of the signals transmitted by the sensors is “taught.”

Alternatively or additionally, each sensor may comprise a kind of individual identification, which can, for example, be transmitted to the monitoring apparatus together with the signals encoding the physical characteristics. An individual position of a sensor individualized by the identification thereof can be established and stored in advance, taught within the context of a learning phase, and/or established, for example, on the basis of other position-dependent characteristics.

It should be noted that some of the possible features and advantages of the invention are described herein with reference to different embodiments. In particular, some possible features and advantages are described with reference to a supporting means designed according to the invention, with reference to an elevator installation designed according to the invention, or with reference to a method for monitoring a state of a supporting means that is to be carried out according to the invention. A person skilled in the art can recognize that the features described and advantages resulting therefrom can be combined, adapted, transferred or exchanged as appropriate in order to yield further embodiments of the invention.

Embodiments of the invention will be described below with reference to the accompanying drawings, neither the drawings nor the description being intended to be interpreted as limiting the invention.

### DESCRIPTION OF THE DRAWINGS

FIG. 1 shows an elevator installation according to an embodiment of the present invention.

FIG. 2 is a perspective sectional view through a supporting means according to an embodiment of the present invention.

FIG. 3 is a perspective sectional view through a supporting means according to an embodiment of the present invention.

FIG. 4 is a perspective sectional view through a supporting means according to an embodiment of the present invention.

The drawings are merely schematic and not to scale. Like reference signs refer in different drawings to like or analogous features.

### DETAILED DESCRIPTION

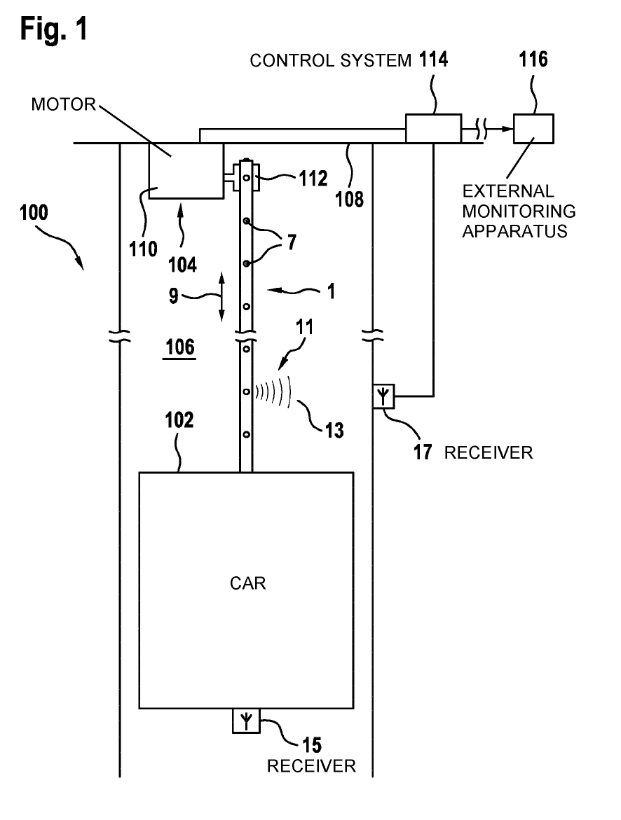

FIG. 1 shows an elevator installation 100 comprising therein a supporting means or belt 1 according to the invention.

The elevator installation 100 comprises an elevator car 102, which can be moved upwards and downwards inside an elevator shaft 106 by means of a drive 104. In the example shown, the drive 104 is attached to a ceiling 108 of the elevator shaft 106; however, said drive could alternatively be housed in a separate engine room, for example. The drive 104 comprises an electric motor 110, by means of which a drive sheave 112 can be driven in a rotatory manner. A surface of the drive sheave 112 may be in frictional contact with a contact surface of the supporting means 1, such that the supporting means 1 can be displaced along the direction of longitudinal extent 9 thereof by the drive sheave 112 being rotated. In the example shown, an end of the supporting means 1 is fastened to the elevator car 102 in this case, in order to hold the elevator car 102. Alternatively, the supporting means 1 may also wind around a pulley attached to the elevator car 102 and be attached at the end thereof to the ceiling 108. An opposite end of the supporting means 1 may optionally hold a counterweight (not shown). As a result of the supporting means 1 moving, the elevator car 102 and, optionally, the counterweight can thus be moved inside the elevator shaft 106. The drive 104 can be controlled in this case by a control system 114.

During operation of the elevator installation 100, it must be ensured that the supporting means 1 can at all times reliably fulfill its task of holding the elevator car 102. For this purpose, a state of the supporting means 1 that reflects the integrity of the supporting means 1 should be monitored permanently or at least at suitable time intervals.

The elevator installation 100 proposed here comprises a plurality of sensors 7 on the supporting means 1 thereof for this purpose. The sensors 7 are arranged on the supporting means 1 at multiple positions which are spaced apart from one another along a longitudinal direction of extent 9 of the supporting means 1. In other words, it is not only the case that sensors 7 are arranged at the ends of the supporting means 1 or that the entire supporting means is connected to an external sensor system, as has conventionally usually been the case, but rather multiple sensors 7 are distributed over the length of the supporting means 1, such that one or more sensors 7 are located, for example, in or near a center of the supporting means 1 in the direction of longitudinal extent 9.

Each of the sensors 7 is designed to determine at least one physical characteristic of the supporting means 1 in a region locally adjacent to the respective sensor 7 and to output a suitable signal 11 on the basis of the determined physical characteristic. A local expansion of the supporting means 1, a local bending of the supporting means 1, a local acceleration of the supporting means 1, a force acting locally on the supporting means 1, a local temperature of the supporting means 1 and/or an electrical conductivity through the supporting means 1 may be determined as a physical characteristic, for example. For this purpose, a sensor 7 may be in mechanical, electrical, thermal or similar contact with the supporting means 1 or with the components thereof, such as load-bearing elements or a casing surrounding said elements.

In this case, a sensor 7 is designed to output, in the form of the signal 11, the physical characteristic measured or detected thereby. The signal 11 may be output for example as a radio signal, i.e. in the form of an electromagnetic wave 13. Receivers 15, 17 that can receive and pass on this signal 11 in a suitable manner may therefore be provided in or on the elevator shaft 106.

For example, a receiver 15 may be attached to the elevator car 102 such that said receiver travels with the elevator car 102 through the elevator shaft 106 and is thereby guided, for example, past sensors 7 which are arranged in a region of the suspension 1 near the ends opposite the elevator car 102. During operation of the elevator installation 100, a receiver 15 of this kind attached to the elevator car 102 therefore moves past many of the sensors 7 attached to the supporting means 1 and/or is located near the sensors 7 that are attached to the supporting means 1 near the elevator car 102. Data transmission to this receiver 15 may therefore only have to bridge short distances. A good quality of data transmission can therefore be achieved.

Alternatively or additionally to a receiver 15 of this kind attached to the elevator car 102 and moved therewith, a receiver 17 can be installed in a stationary manner in or on the elevator shaft 106. For example, a stationary receiver 17 of this kind may be arranged near the center of the elevator shaft 106. Many of the sensors 7 attached to the supporting means are thereby conveyed past the receiver 17 multiple times during the movement of the supporting means 1 taking place in operation of the elevator 100. Signal transmissions therefore have to take place only over short distances. In this way, reliable data transmission from each of the sensors 7 to the receiver 17 is also possible.

A plurality of receivers 15, 17 may also be provided. For example, multiple stationary receivers 17 may be arranged along the height of the elevator shaft 106.

The receivers 15, 17 may pass on the signals 11 received thereby from the sensors 7 to the control means 114, for example. The signals 11 can be processed there in order that it is possible to determine the desired information regarding the state of the supporting means 1 therefrom. Alternatively or additionally, the signals 11 may be transmitted to an external monitoring apparatus 116 in order to be able to evaluate the signals 11 and to be able to remotely monitor the state of the elevator installation 100, and in particular the supporting means 1 accommodated therein, therefrom, i.e. for example from a remote control center.

As an alternative to wirelessly transmitting the signals 11 using the electromagnetic waves 13, the signals 11 may also be conducted to the control means 114 and/or to the external monitoring apparatus 116 by means of electric lines that are accommodated in the supporting means 1 or are attached to the supporting means 1.

In particular, the fact that electrically conductive structures are usually accommodated in any case in the supporting means 1 in the form of metal load-bearing elements that are accommodated therein and can also be used for transmitting signals through the supporting means 1 ultimately to the control system 114 or to the external monitoring apparatus 116 can be used advantageously. For this purpose, the sensors 7 may couple signals generated therefrom e.g. into one of the electrically conductive load-bearing elements. At one location, e.g. at one end of the supporting means 1, the load-bearing element used for conducting signals can then be connected to the outside to a line connected to the control system 114 or the monitoring apparatus 116, for example.

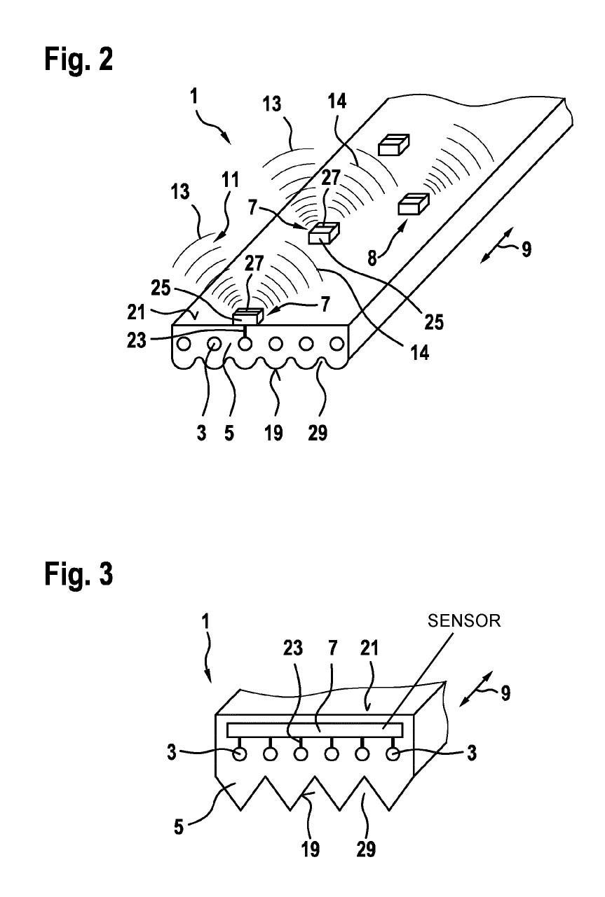

FIGS. 2 to 4 show different embodiments of supporting means 1 in a perspective sectional view.

Each supporting means 1 comprises load-bearing elements 3, which are surrounded by a casing 5. The supporting means 1 shown is a flat belt in the case of which multiple load-bearing elements 3 extend in parallel with the direction of longitudinal extent 9 of the supporting means 1 and are arranged adjacently so as to be mutually parallel. Load-bearing elements 3 of this kind of a belt are also referred to as “cords” and may comprise, for example, a braid or a bundle of metal wires or consist thereof. The load-bearing elements 3 may have a diameter in the range of from typically one or a few millimeters to a few centimeters. A lateral distance between adjacent load-bearing elements 3 may be of the same order of magnitude as the diameter of the load-bearing elements, i.e. may be in the range of from a few millimeters to several centimeters.

In the embodiment of the supporting means 1 formed as a belt by way of example, each of the load-bearing elements 3 is surrounded by part of a casing 5, such that the load-bearing elements 3 are separated from one another both mechanically and electrically. The casing 5 may consist of a plastics material, in particular of a polymeric material, preferably an elastomeric material. In this case, the casing 5 forms, together with the load-bearing elements 3 accommodated therein, a unit in the form of the belt forming the supporting means 1.

During use of the supporting means 1, a front surface 19 of the belt forms the contact surface via which the supporting means 1, for example, is in frictional contact with the drive sheave 112 of the drive 104. This front surface 19 may be textured or smooth, for example. A textured front surface 19 may, for example, comprise a plurality of mutually parallel channels or grooves 29. A rear surface 21 located opposite the front surface 19 is usually smooth, i.e. not textured.

Alternatively to a belt provided with multiple load-bearing elements 3, the supporting means 1 could also be provided with merely a single load-bearing element 3 as the core and a casing surrounding said core.

In the example shown in FIG. 2 of a belt-like supporting means 1, multiple sensors 7 are attached to the rear surface 21 of the casing 5 along the direction of longitudinal extent 9. The sensors 7 are applied to the rear surface 21 and are mechanically connected thereto or mechanically fastened therein.

In this case, a protrusion 23 projects into the casing 5, for example. This protrusion 23 can ensure mechanical fastening of the sensor 7. This protrusion 23 can also establish sensory contact with one of the load-bearing elements 3 inside the casing 5, such that the sensor 7 is connected via this protrusion 23 to the load-bearing element 3 mechanically, electrically, thermally or in a similar manner, for example. In this way, the sensor 7 can determine physical characteristics of the supporting means 1 and in particular of the load-bearing elements 3 accommodated therein.

For example, the sensor 7 can detect, via the protrusion 23, a local expansion or bending of the load-bearing element 3. For this purpose, changes in length, changes in orientation and/or changes in voltage, for example, inside the load-bearing element 3 can be measured.

Alternatively or additionally, the sensor 7 can measure, directly or optionally by means of the protrusion 23 thereof, forces or accelerations acting locally on the supporting means 1, in particular forces or accelerations acting locally on the load-bearing element 3 accommodated in said supporting means.

Temperatures such as those prevailing locally on the rear surface 21 or inside the supporting means 1, for example on a contacted load-bearing element 3, can also be measured by the sensor 7.

It is also conceivable to design the sensors 7 and attach them to the supporting means 1 such that said sensors can be used to generate electrical currents locally through one of the load-bearing elements 3. For example, an electrical voltage between two adjacent sensors 7 can be generated and as a result an electrical current flow through the load-bearing element 3 connecting said sensors can be produced. In particular, changes to an electrical current produced in this manner may indicate possible damage to the load-bearing element 3. In this case, advantageously, the damage may be not only identified, but also located in the region between the two sensors 7.

In the example shown, each sensor 7 is provided with a sensor system 25 and a sending and/or receiving unit 27. The sensor system 25 is used in this case to measure the physical characteristic to be determined of the supporting means 1. The sending and/or receiving unit 27 can then convert the determined measuring signal into a signal 11 to be output. This signal 11 can then be transmitted to the control system 114 and/or the external monitoring apparatus 116 to be further processed and evaluated.

Signal transmission of this type can in turn take place wirelessly, for example by means of electromagnetic waves 13. Alternatively, the sending and/or receiving unit 27 may couple, via the protrusion 23, the generated signal 11 into the electrically conductive load-bearing element 3 and transmit said signal to the control system 114, and optionally further to the external monitoring apparatus 116, for example, via said element. Individually wiring each sensor 7 would be conceivable as another alternative.

In the example shown in FIG. 2, furthermore, adjacent sensors 7 cannot exchange signals 11 and data merely with the control system 114 and/or the external monitoring apparatus 116, but rather signal transmission between adjacent sensors 7 is conceivable. In this case, the adjacent sensors 7 can communicate with one another wirelessly, for example by means of electromagnetic waves 14. In this way, an exchange of information between sensors 7, for example, is conceivable.

In particular, it is conceivable that adjacent sensors 7 can, for example, coordinate an electrical current flow through a piece, connecting said sensors, of a load-bearing element 3 in order to be able to locally determine a change in electrical resistance or another electrical value inside the load-bearing element 3. In this way, it is in particular possible to allow changes in electrical characteristics inside load-bearing elements 3 of a supporting means 1 to be determined and evaluated not only globally, i.e. for the entire load-bearing element 3, but also locally, i.e. for example in regions between two adjacent sensors.

In the example shown in FIG. 2, sensors 7 can be attached to the supporting means 1 along the direction of longitudinal extent 9 such that said sensors each contact the same load-bearing element 3 (third from left in the example shown) and determine corresponding local physical characteristics near this load-bearing element 3. However, additional sensors 8 may also be arranged on the supporting means 1, using which sensors, for example, other physical characteristics, such as a temperature or similar, can be measured locally, on the basis of which additional information regarding a current local state of the supporting means 1 can preferably be derived.

In the example of a supporting means 1 shown in FIG. 3, a sensor 7 is integrated in the casing 5 of the supporting means 1. In other words, the sensor 7 is located completely inside the casing 5 and is therefore protected, similarly to the load-bearing elements 3, by the casing 5 against mechanical and/or chemical influences. In the example shown, the sensor 7 extends substantially over the entire width of the belt-like supporting means 1. A plurality of protrusions 23 contact each of the load-bearing elements 3 accommodated in the supporting means 1. Physical characteristics of the supporting means 1 may in this case be locally determined in regions on or adjacent to each of the load-bearing elements 3.

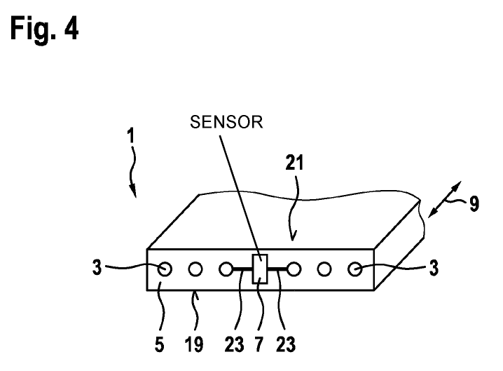

In the embodiment shown in FIG. 4 by way of example, a sensor 7 is accommodated even deeper inside the supporting means 1. In particular, the sensor 7 is accommodated laterally between adjacent load-bearing elements 3 and is therefore located deep inside the casing 5. In this case, the sensor 7 may in turn contact, by means of protrusions 23, one or, in the example shown, two load-bearing elements 3 that extend adjacently thereto in order to be able to locally determine the physical characteristics of said elements.

In addition to the possibility, as already explained, of signal transmission from the sensor 7 to the control system 114 and/or the external monitoring apparatus 116 through one of the load-bearing elements 3, the sensor 7 may be supplied with energy with the aid of one or more load-bearing elements 3 accommodated in the supporting means 1. For example, a sensor, as shown in FIG. 4, may contact, by means of protrusions 23 or other contacting means, two separate load-bearing elements 3 to which a suitable electrical voltage has been applied externally, in order to be able to ensure energy supply for the sensor 7 by means of a current flow through the load-bearing elements 3.

Alternatively, the sensors 7 may be formed as passive components or may each be equipped with an individual energy supply, such as a battery.

Finally, possible designs of embodiments of a supporting means according to the invention or of an elevator installation equipped therewith or of a monitoring process that can be carried out using said supporting means and advantages that can be achieved thereby can be summarized as follows, partially by using an alternative word choice to the description above:

Arranging multiple sensors on or inside a supporting means so as to be distributed over the length thereof can be considered a core aspect.

The sensors may be small enough to be attached only locally to the supporting means or even to integrate them in said means. Physical characteristics such as a bending, a loading, a temperature and/or a vibration on or in the supporting means can be identified using these sensors.

For example, the sensors in the supporting means can be used to determine how often a portion of the supporting means is bent. It is possible to derive therefrom, for example, when a discard criteria for the supporting means is reached. This can have the advantage, inter alia, that a history of an entire travel region of the supporting means can be determined and the supporting means can be replaced at the right time, without falling below a required breaking load, for example.

Unacceptably high local accelerations may be suggestive of a defect, and therefore the elevator installation can be taken out of operation. The state of the supporting means determined on the basis of signals from the sensors can be evaluated by a control system or an external monitoring apparatus and, for example, associated information can be passed on to an elevator control system. Essentially, a change in acceleration behavior compared with a new state, for example, may lead to premature end of operation of the supporting means.

The supporting means can be better used, depending on the use of the elevator, up to its discard criteria using a history of the complete length of the supporting means and of the respective bending profile. Hitherto, only a number of journeys of the elevator installation have been evaluated for this purpose. Furthermore, an online query as to a state of the supporting means of the elevator installation is possible at any time via a telemonitoring system. As a result, for example, timely service planning can prevent downtime, for example.

In a specific embodiment, a loading state can be determined very precisely by means of information regarding respective tensile stress in a supporting means, for example, which tensile stress is detected by the sensors. This information can provide the loading state of the car to the control system. Additionally, differences in tension inside multiple supporting means can be displayed to a technician and can be readjusted during installation or in a servicing situation. This means that, inter alia, the service life of the supporting means can be better utilized and travel comfort can be maintained.

If there is a loose segment or an entire supporting means region due to a fault, for example, this can be detected immediately. Advantageously, there is no delay at all inside a sensor chain.

Furthermore, precise monitoring of the supporting means can lead to an adjustment in a safety assessment and can re-evaluate historic safety factors on the basis of inadequate state information.

Temperatures in individual segments of the supporting means can provide information in the event of a fire. For example, a travel distance inside the elevator installation can be restricted and therefore the system can remain in operation for longer.

According to a possible embodiment, multiple individual sensors are attached in or on the supporting means at a specific spacing. The sensors may, for example, be arranged on the rear or on the running profile of the supporting means or in the supporting means. The sensors may be connected to electrically conducting cords and/or fibers or may be attached thereto in an electrically insulated manner. A signal can be transmitted either to an end point via a conductor or directly to a receiver via telemetry. During initial installation or servicing, a position of the sensor system can be taught by means of a teach-in process, which can provide additional information, but is optional. Information on supporting means such as time of production, production batch or supporting means type can be stored in the sensor system directly by the manufacturer. Temperature information, acceleration states and supporting means tensions over local portions can be supplied to the control system for further processing.

Finally, it should be noted that terms such as “comprising,” “having,” etc. do not preclude other elements or steps and terms such as “a/an” or “one” do not preclude a plurality. Furthermore, it should be noted that features or steps that have been described with reference to one of the embodiments above can also be used in combination with other features or steps of other embodiments described above.

In accordance with the provisions of the patent statutes, the present invention has been described in what is considered to represent its preferred embodiment. However, it should be noted that the invention can be practiced otherwise than as specifically illustrated and described without departing from its spirit or scope.

### LIST OF REFERENCE NUMERALS

1 supporting means
3 load-bearing element
5 casing
7 sensor
8 additional sensor
9 direction of longitudinal extent
11 signal
13 electromagnetic wave
14 electromagnetic wave
15 receiver
17 receiver
19 front surface
21 rear surface
23 protrusion
25 sensor system
27 sending and/or receiving unit
29 channel or groove
100 elevator installation
102 elevator car
104 drive
106 elevator shaft
108 ceiling
110 motor
112 drive sheave
114 control system
116 external monitoring apparatus

1-14. (canceled)

15. A supporting means for an elevator installation comprising:
at least one elongate load-bearing element;
a casing surrounding the at least one load-bearing element; and
a multiplicity of sensors arranged on the supporting means at multiple positions that are spaced apart from one another along a direction of longitudinal extent of the supporting means,
each of the sensors being adapted to determine at least one physical characteristic of the supporting means in a region locally adjacent to the sensor and to output a signal indicating the determined physical characteristic, and
wherein for each of the sensors the at least one physical characteristic is selected from a group comprising a local expansion of the supporting means, a local bending of the supporting means, a local acceleration of the supporting means, a force acting locally on the supporting means, a local temperature of the supporting means and an electrical conductivity through the supporting means.

16. The supporting means according to claim 15 wherein the sensors transmit the signal determined physical characteristic to at least one of a remote control system and an external monitoring apparatus.

17. The supporting means according to claim 16 wherein at least one of the sensors transmits the signal wirelessly.

18. The supporting means according to claim 15 wherein at least one of the sensors is connected to the at least one load-bearing element for transmitting the signal through the at least one load-bearing element.

19. The supporting means according to claim 15 wherein at least part of one of the sensors penetrates the casing and is in contact with the at least one load-bearing element.

20. The supporting means according to claim 15 wherein at least one of the sensors is integrated in the casing.

21. The supporting means according to claim 15 wherein at least one of the sensors is formed as a miniaturized component based on a semiconductor.

22. The supporting means according to claim 15 wherein at least one of the sensors is adapted to determine the at least one physical characteristic and transmit the signal without a separate energy supply.

23. The supporting means according to claim 15 wherein at least one of the sensors is connected to the at least one load-bearing element to supply the at least one sensor with electrical energy via an electric current flow through the at least one load-bearing element.

24. The supporting means according to claim 15 including multiple load-bearing elements that extend in parallel with one another and the sensors are adapted to determine the at least one physical characteristic in at least one of the load-bearing elements in a region locally adjacent to respective ones of the sensors.

25. The supporting means according to claim 15 wherein the sensors (7) are arranged along the direction of longitudinal extent with adjacent ones of the sensors equidistantly spaced apart from one another.

26. An elevator system comprising:
an elevator car;
a drive; and
a supporting means according to claim 15 wherein the elevator car is supported on the supporting means and the elevator car is displaced by the supporting means being moved by the drive.

27. The elevator system according to claim 26 including an external monitoring apparatus for receiving the signal that indicates the determined physical characteristic from each of the sensors arranged on the supporting means and for determining information regarding a state of the supporting means by processing received signals.

28. A method for monitoring a state of the supporting means according to claim 15, the method comprising the steps of:
selecting the at least one physical characteristic from the group comprising the local expansion of the supporting means, the local bending of the supporting means, the local acceleration of the supporting means, the force acting locally on the supporting means, the local temperature of the supporting means and the electrical conductivity through the supporting means;
receiving the signals indicating the determined physical characteristic of the supporting means from the sensors arranged on the supporting means at multiple positions; and
determining information regarding a state of the supporting means by processing the received signals.
